(19) United States
(12) Patent Application Publication
(10) Pub. No.: US 2006/0031465 A1
(43) Pub. Date: Feb. 9, 2006

(54) Method and system of arranging configurable options in a user interface

(75) Inventors: Deepak P. Ahya, Plantation, FL (US); Daniel A. Baudino, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/854,109

(22) Filed: May 26, 2004

(51) Int. Cl. G06F 15/173

(52) U.S. Cl. 709/224

(57) ABSTRACT

A method (500) of arranging configurable options such as hot/soft keys in a menu can include tracking (502) a sequence of events initiated by a user on a device having a user interface and an application, tracking (504) the number of times an event occurs during a given time, and tracking (506) the time between user initiated events. The method can further include generating (509) a pattern from the tracking steps, associating (510) the pattern with a user profile, and optimizing (512) an arrangement of hot/soft keys in the menu based on the user profile. The method can optionally track (508) user habits and dynamically arrange (513) the hot/soft keys based on the dynamic user profile. Furthermore, performance enhancements for use of the user interface and applications based on the dynamic user profile can be dynamically identified (514).

### CROSS-REFERENCE TO RELATED APPLICATIONS

See Docket No. 7463-52 and 7463-54 concurrently filed herewith.

### FIELD OF THE INVENTION

This invention relates generally to user interfaces, and more particularly to a method and system for arranging configurable options such as Hot/Soft keys, menus, shortcuts, quick links, or any other configurable option in a user interface (UI).

### BACKGROUND OF THE INVENTION

As mobile devices and other electronic appliances become increasingly feature rich, their respective user interfaces are getting more complex. Marketing studies have indicated that approximately 90% of the users seem to be using 10% of the features available. Part of the blame can be placed on the complexity of the overall user interface and more specifically because users get lost in the Main Menu or Application Menus. Since many products today are designed to satisfy the needs of many, an inordinate amount of logical options are provided for Main menus and Application menus. Unfortunately, the numerous options result in a significant number of key presses or steps for all users.

Existing UIs use soft/hot keys to allow a user a direct link to some applications. The existing soft/hot keys are sometimes user programmable, but remain static once programmed by the user. The soft/hot keys help the user to reduce the number of keystrokes to execute a desired application and to optimize the UI based on the features/applications available and their intended use. Unfortunately, since existing soft/hot key features are static, no consideration is given by the soft/hot key function to the context in which a user is currently operating a device. Existing hot/soft keys features fail to provide a dynamically changing hot/soft key function based on changing context. Existing hot/soft key functions also fail to account for a user's habits in traversing through application menus, submenus and the like. Further, once the hot/soft keys are established, there is no assistance provided and no tracking of the use of these easy access links (hot/soft keys).

Although there are systems that change computer user interfaces based on context, such schemes use limited templates that are predefined and fail to learn from a user's habits to re-organized menus (as well as submenus and application menus) and fail to provide smart assist messages. In yet other existing systems by Microsoft Corporation for example, task models are used to help computer users complete tasks. In this scheme, tasks are viewed in a macro sense such as writing a letter. User inputs are collected in the form of tasks that are then logged and formatted in a such a way (adds a parameter) that they can be parsed into clusters (similar tasks). The application uses this information to complete tasks or provide targeted advertisement. Again, such systems fail to learn from a user's habits and fail to provide smart assist messages. In yet another scheme, a teaching agent that “learns” and provides an advisory style (as oppose to assistant style) help agent exists. The agent is a computer program which simulates a human being and what another human being would do. Such a system fails to analyze a user's work as it is deemed computationally impractical if such a system tries to learn or understand semantics. It breaks down users into experts, intermediate and novice. The user background is stored in adaptive frames. The system learns about user competency based on adaptive frames information. In a nutshell, such a system focuses on modeling a user to understand the competency level so pre-programmed advisory style help can be provided (e.g. appropriate level of examples, guidance on goal achievement etc.) Such a system uses a competence assessment to go to pre-programmed messages and examples. Such a system fails to focus on understanding where a user has been in the past and what are the likely places he/she might be going.

### SUMMARY OF THE INVENTION

Embodiments in accordance with the present invention provide a method and system for a learning user interface framework that can include an event tracker, a time and a pattern/profile generator in an effort to intelligently arrange configurable options in a user interface. Optionally, the framework can also include a configurable options manager such as a soft/hot keys manager and an advisor manager when soft/hot keys are used as configurable options.

In a first embodiment of the present invention, a method of arranging configurable options such as hot/soft keys in a menu can include the steps of tracking a sequence of events initiated by a user on a device having a user interface and at least one application, tracking the number of times an event occurs during a given time, and tracking the time between user initiated events. The method can further include the steps of generating a pattern from the tracking steps, associating the pattern with a user profile, and optimizing an arrangement of hot/soft keys in the menu based on the user profile. The method can also include the steps of tracking user habits, generating a dynamic user profile based on the user habits, and dynamically arranging the hot/soft keys based on the dynamic user profile.

In a second embodiment of the present invention, a dynamically enhanced user interface having configurable options such as hot/soft keys in a menu can include an event tracker, and an elapsed time tracker. The user interface can also include a user pattern profile generator receiving inputs from the event tracker, the time tracker (and/or time of day tracker) for generating a user pattern profile in response to such inputs, and a presentation device such as a display having (for example) a set of hot/soft keys that dynamically changes based on the user pattern profile. In addition, the user interface can further include a configurable option manager such as a soft/hot key manager that controls the arrangement of the soft/hot keys based on the user pattern profile generator and an advisor manager that monitors user pattern profiles and suggests improvements in usage to a user.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram learning user interface (UI) framework or architecture in accordance with an embodiment of the present invention

FIG. 2 is a block diagram of a learning UI module in accordance with an embodiment of the present invention.

FIG. 3 is a block diagram of an event/time tracker architecture for the UI module of FIG. 2.

FIG. 4 is an application tree diagram illustrating user behavior by how many times an application was used in accordance with an embodiment of the present invention.

FIG. 5 is a more specific application tree diagram corresponding to the application tree diagram of FIG. 4.

FIG. 6 is another application tree diagram illustrating the assignment of a soft/hot key in accordance with an embodiment of the present invention.

FIG. 7 is a more specific application tree diagram corresponding to the application tree diagram of FIG. 6 along with a corresponding graphical UI in accordance with an embodiment of the present invention.

FIG. 8 is an updated application tree diagram of FIG. 6 illustrating new usage patterns by a user and a re-assignment of a hot/soft key in accordance with and embodiment the present invention.

FIG. 9 is a more specific application tree diagram along with a corresponding graphical UI in accordance with and embodiment of the present invention.

FIG. 10 is a block diagram of a learning UI module having an advisor manager in accordance with an embodiment of the present invention.

FIG. 11 is a block diagram of an event/time tracker architecture for the UI module of FIG. 10.

FIG. 12 is an updated application tree diagram of FIG. 6 illustrating new usage patterns by a user where lack of use of a hot/soft key is noted in accordance with an embodiment of the present invention.

FIG. 13 is a more specific application tree diagram corresponding to the application tree diagram of FIG. 12.

FIG. 14 is a graphical user interface providing advice regarding an unused shortcut in accordance with an embodiment of the present invention.

FIG. 15 is a flow chart illustrating a method of arranging hot/soft keys in a menu in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

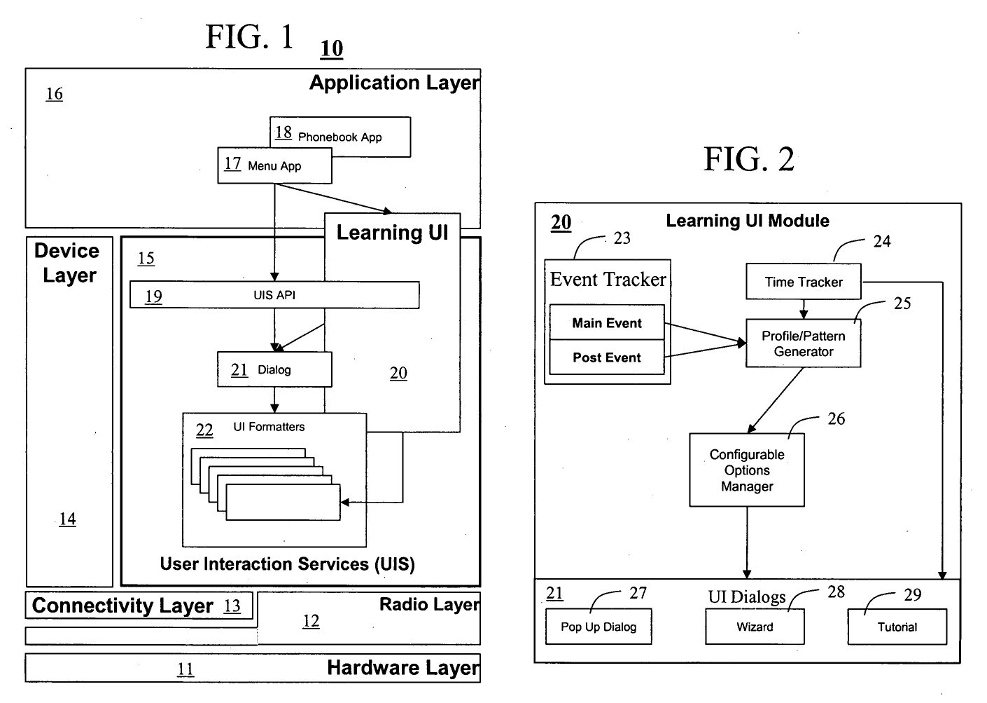

A method of arranging hot/soft keys in a menu can include a learning user interface architecture 10 as illustrated in FIG. 1. The architecture 10 is suitable for most electronic appliances and particularly for mobile devices although desktop appliances can equally benefit from the concepts herein. The architecture 10 can include a hardware layer 11 and a hardware abstraction or radio layer 12 as well as an optional connectivity layer 13. The architecture 10 can further include a device layer 14 that can include a user interaction services (UIS) module 15. The device layer 14 can define the functions and interactions that a particular device such as a cellular phone, laptop computer, personal digital assistant, MP3 player or other device might have with the remainder of the architecture. More likely, the UIS module 15 can be a separate module interacting responsively to the device layer 14 and other layers in the architecture 10. The architecture 10 can further include an application layer 16 that can include one or more applications such as a menu application 17 and a phonebook application 18 as examples.

The UIS module 15 can include a UIS application programming interface (API) 19 and a Learning User Interface (UI) module 20 that receives inputs from the application layer 16. The UIS API 19 and the Learning UI module 20 can provide inputs to a dialog block 21. The dialog block 21 and the Learning UI can also correspondingly provide inputs to a formatter 22.

Referring to FIGS. 1 and 2, the dialog block 21 can provide a user with assistance in various forms using pop-up dialogs 27, wizards 28, and tutorials 29. Referring to FIG. 2, the Learning UI module 20 can include an event tracker 23, a time tracker 24, a profile/pattern generator 25, and a configurable options manager 26 such as a soft/hot key manager. The event tracker 23 can record key sequences, UI Start and end events (actions), applications launched, and other events. The event tracker can track a main event such as the launch of an application and then track subsequent events such as the user's traversal through menu and sub-menu selections within the application. The time tracker 24 can include a macroscopic and a microscopic time monitor. The macroscopic time module monitors the number of times a particular event pattern occurs within a given time whereas the microscopic time module detects the gap or elapse time between key presses. The microscopic time module enables the detection of pauses between key presses. The time tracker 24 is primarily used to detect when and how often the events occurred.

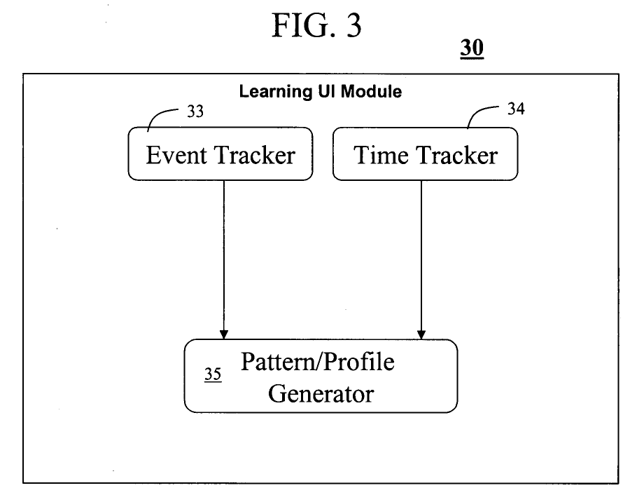

The pattern/profile generator 25 records the behavior of the user on time and can use the information from the tracking modules mentioned above to process them to produce patterns, and associations creating a unique profile for a user based on patterns detected. The user behavior can include how, when and where applications are launched, how long the applications are used, intervals between usages and other user behavior patterns. In a simpler view as shown in FIG. 3, a learning UI module and event/time tracker architecture 30 can just include an event tracker 33, a time tracker 34, and a pattern/profile generator 35 all functioning as similarly described with respect to the event tracker, time tracker, and pattern/profile generator of FIG. 2.

In several embodiments as described herein, several methods can re-arrange hot/soft keys on an idle Screen, a Menu, a sub menu, or application menus or other formats based on information gathered by the pattern/profile generator. User profiles can be generated based on combined knowledge of event and temporal patterns derived from tracking such events as start/end events, key sequences, and time patterns for example. The methods can adapt the UI when some hot/soft keys are not used anymore or some other action is more preferred by users. The decision making process on how to arrange the hot/soft keys or modify other configurable options can be done using a weighted average of factors that can also be programmable or determined by the user. Note that the weighting of factors can also be preset.

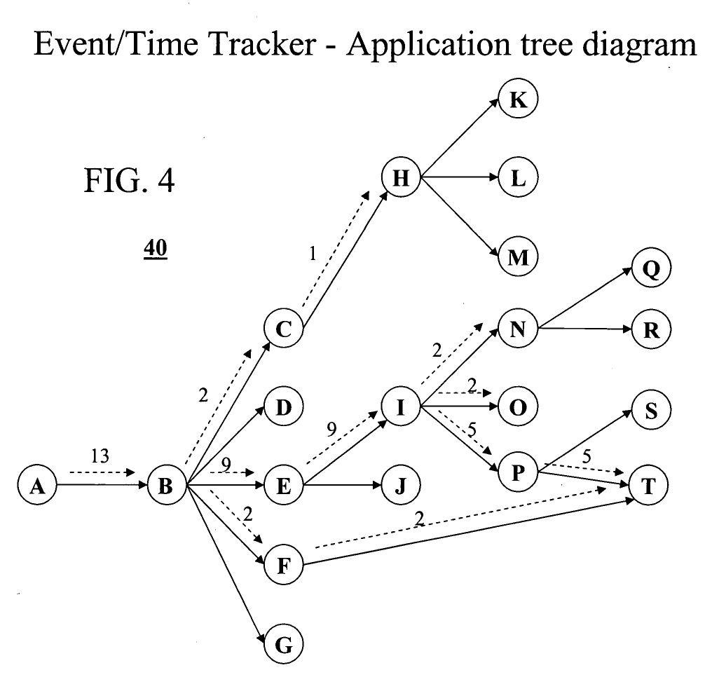

Referring to FIG. 4, a generic application tree diagram 40 is shown illustrating in this example that the application “T” was one of the most used applications. The event and time trackers record the behavior of the user on time. In this instance, the user behavior noted or recorded can be applications used (events), the number of times the application was used, how long the particular application was used, and the pauses between usage. The pattern recorded in this example is (A-B-E-I-P-T). The numbers shown adjacent to the dashed arrows in the tree diagram 40 indicate the number of times the application was used. The same application “T” in this example was executed using (A-B-F-T). Navigating from “A” to “T” using the tree diagram does not mean that the user presses 5 keys. The number of keys pressed usually is higher than the number of events recorded. Also note that embodiments in accordance with the invention are not necessarily limited to key presses, but other inputs such as voice commands are equally contemplated herein.

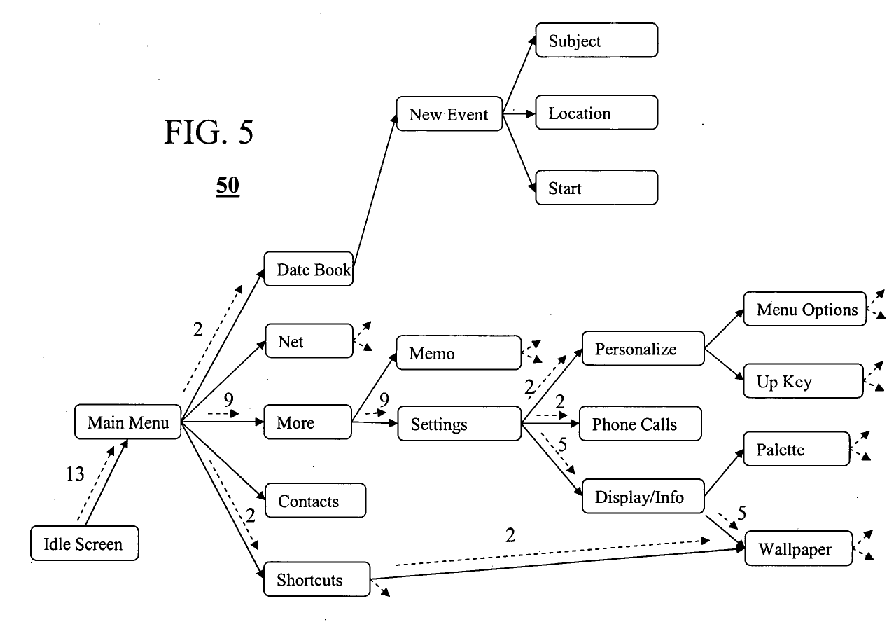

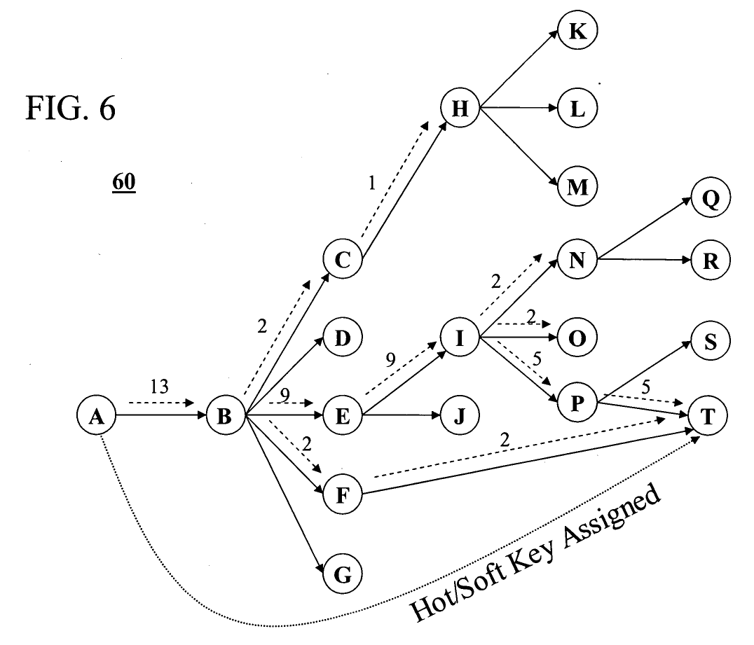

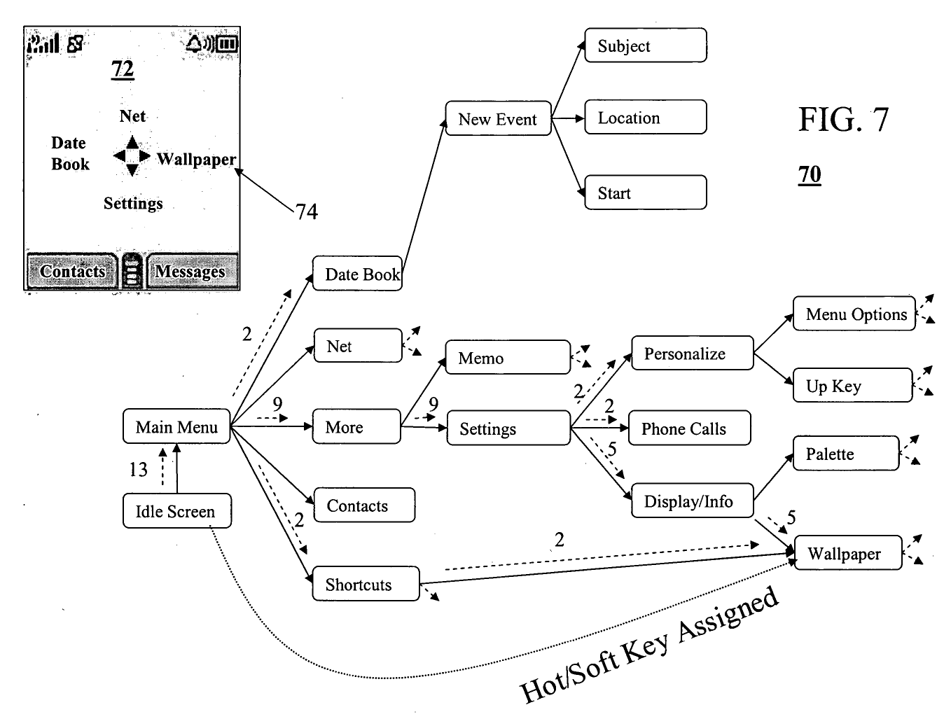

Referring to FIG. 5, a particular example of an application tree diagram 50 corresponding to the application tree diagram of FIG. 4 has several detected patterns as follows: Idle Screen-Main Menu-More-Settings-Display/Info-Wallpaper Idle Screen-Main Menu-Shortcuts-Wallpaper After the information has been collected, the pattern/profile generator can make a decision to adapt the UI and create a means of easy access to an application such as “Wallpaper”. Referring to FIGS. 4 and 6, changes can be made to the UI based on the user behavior. The pattern/profile generator can assign a new hot/soft key to the most frequently used application (or applications). New tree diagrams 60 and 70 as illustrated in FIGS. 6 and 7 respectively show that the action “T” or “Wallpaper” has now a direct line (soft/hot key) from step A or the “Idle Screen”. Now, the same process can be achieved from A or the Idle Screen with one keystroke. As illustrated in the graphical UI 72 of FIG. 7, a soft/hot key 74 for “Wallpaper” represents the newly assigned hot/key as determined by the pattern/profile generator. In other words, the learning UI framework assigns the new soft/hot key to the existing UI based on user behavior. Note that this soft/hot key can change dynamically based on analysis of the user behavior.

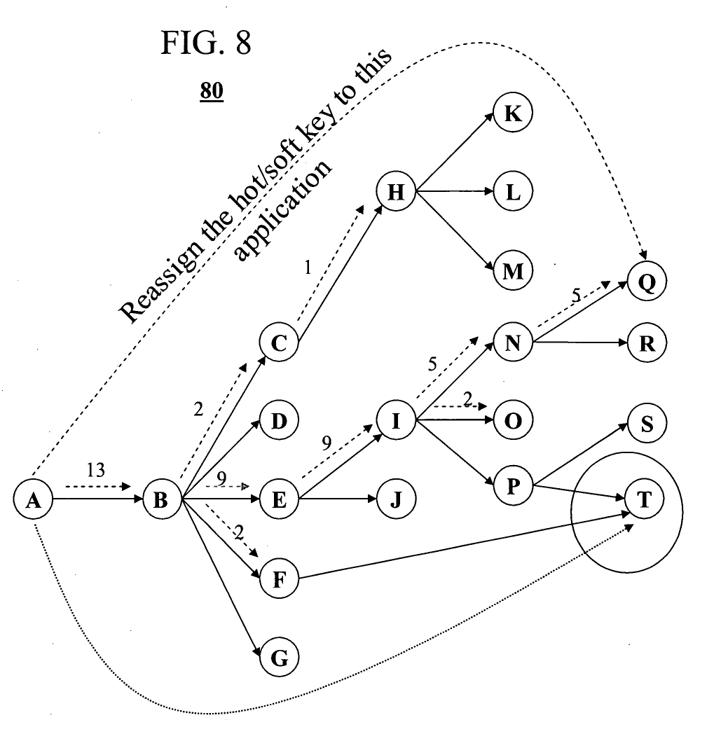

After the adaptation of the UI, the learning UI framework can keep recording the usage of the existing links and any new links introduced. Based on the additional information obtain from the user behavior, the learning UI can suggest changes to the user. If the user behavior changes, the system can detect them. For example, FIG. 8 shows an application tree diagram 80. Diagram 80 illustrates that the “T” (or “Wallpaper” end event as shown in FIG. 7) has not been used over time. The system has detected a new pattern (A-B-E-I-N-Q or Idle Menu, Main Menu, More, Settings, Personalize, Menu Options). In one embodiment, the system can automatically change the soft/hot key to provide a quick one-step navigation to “Q” or “Menu Options.” In another embodiment, the system can give the user a suggestion to change the old soft/hot key to the latest detection or suggestion. The “changes” can be presented to the user in many different ways. For example, the user can be asked to accept the changes, try the changes, reset and start over with the learning, continue learning or disable the learning.

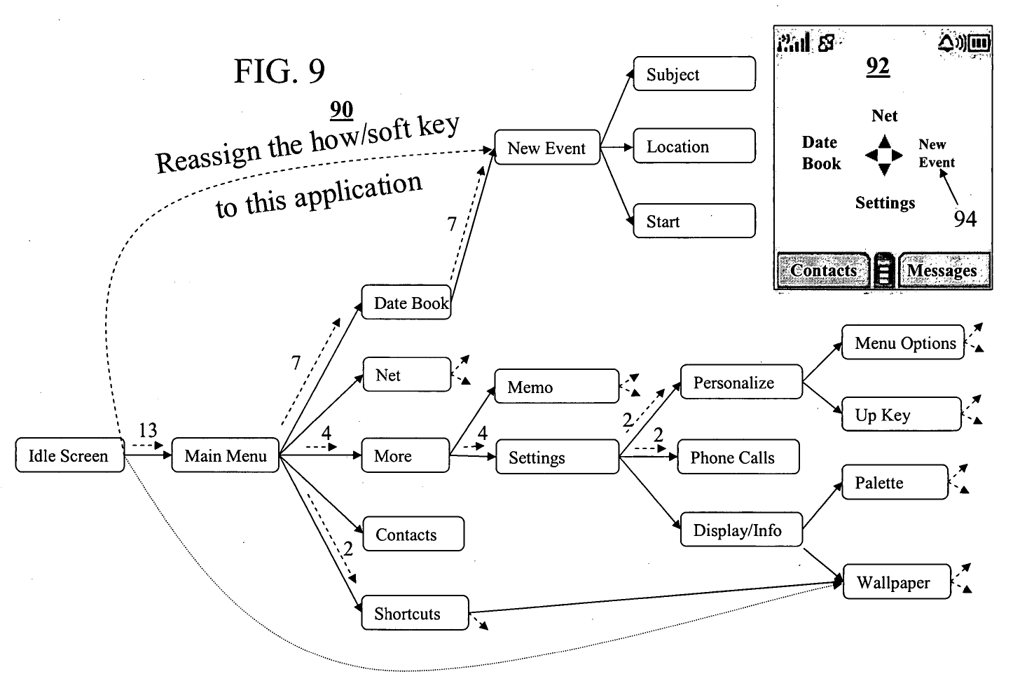

Similarly, FIG. 9 shows another example with an application tree diagram 90 that once again illustrates that the “Wallpaper” has not been used over time. The system has detected a new pattern (A-B-C-H or Idle, Menu, Date Book, New Event). As illustrated in a corresponding graphical UI 92, a soft/hot key 94 for “New Event” represents the newly assigned hot/key as determined by the pattern/profile generator. Using an example of a phone and a user using the phone, a system in accordance with the present invention can continuously track an event and time and offer the optimal UI periodically throughout the life cycle of the phone. The system can also keep tabs on current hot/soft keys (established during previous learning or manually) as part of the tracking.

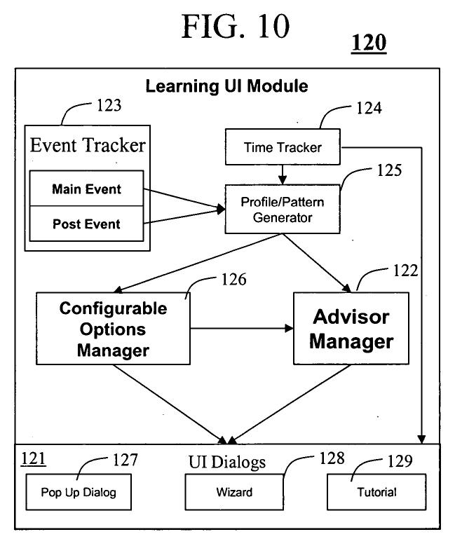

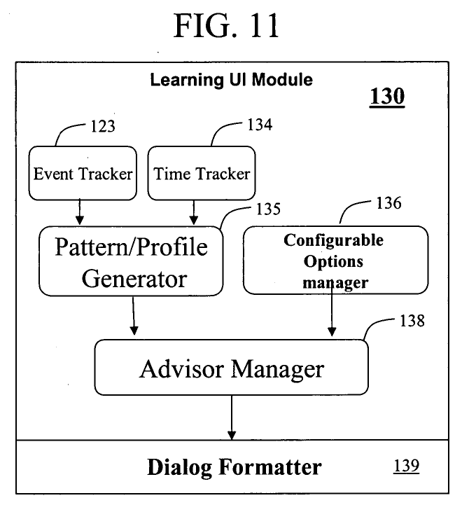

Referring to FIG. 10, another learning UI module 120 is shown. The UI module 120 via a dialog formatter block 121 can provide a user with assistance in various forms using pop-up dialogs 127, wizards 128, and tutorials 129. The Learning UI module 120 can include an event tracker 123, a time tracker 124, a profile/pattern generator 125, a configurable options or soft/hot key manager 126, and an advisor manager 122. The event tracker 123 can record key sequences, UI Start and end events (actions), applications launched, and other events. The event tracker can track a main event such as the launch of an application and then track subsequent events such as the user's traversal through menu and sub-menu selections within the application. The time tracker 124 can include a macroscopic and a microscopic time monitor. The macroscopic time module monitors the number of times a particular event pattern occurs within a given time whereas the microscopic time module detects the gap or elapsed time between key presses. The microscopic time module enables the detection of pauses between key presses. The time tracker 124 is primarily used to detect when and how often the events occurred. In a simpler view as shown in FIG. 11, a learning UI module and event/time tracker architecture 130 can just include an event tracker 123, a time tracker 134, a pattern/profile generator 135, a configurable options or soft/hot key manager 136, and an advisor manager 138 all functioning as similarly described with respect to the event tracker, time tracker, pattern/profile generator, soft/hot key manager, and advisor manager of FIG. 10. The learning UI module 130 can interface with a dialog formatter 139.

Module 120 of FIG. 10 differs from module 20 of FIG. 2 in that the advisor manager 122 is used in the learning UI framework to intelligently advise users. Operationally, the event/time tracker can verify the hot/soft key usage established either manually or by the learning module and the applications usage. If the applications are used but not accessed by means of hot/soft keys presented to the user, then the advisor manager can use this information to generate an informational dialog such as smart pop-ups.

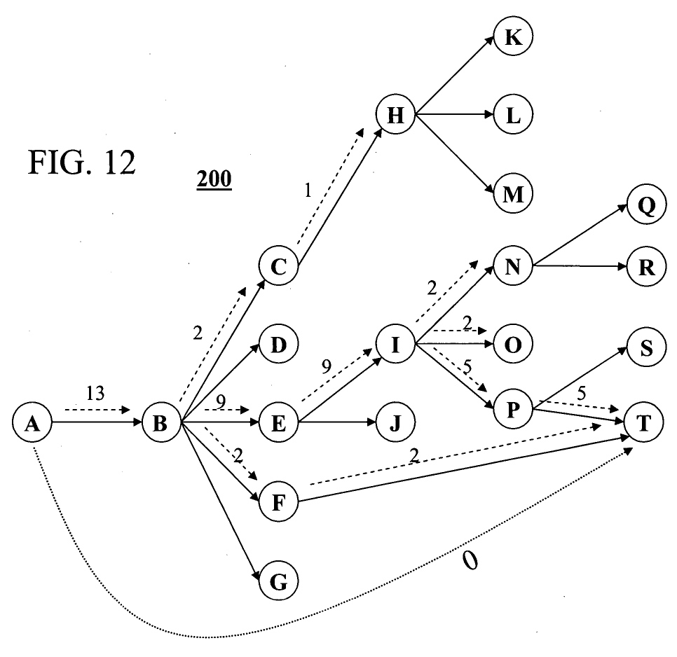

For example, the pattern/profile generator processes the usage of the application and how the user got there. If the application is used, but the user continued using a long pattern (A-B-E-I-P-T 5 times) and (A-B-F-T 2 times) rather than using an appropriate soft/hot key (A-T, never used) as shown in the generic application tree 200 of FIG. 12, the system can advise the user by introducing and encouraging the effective usage of shortcuts or soft/hot keys.

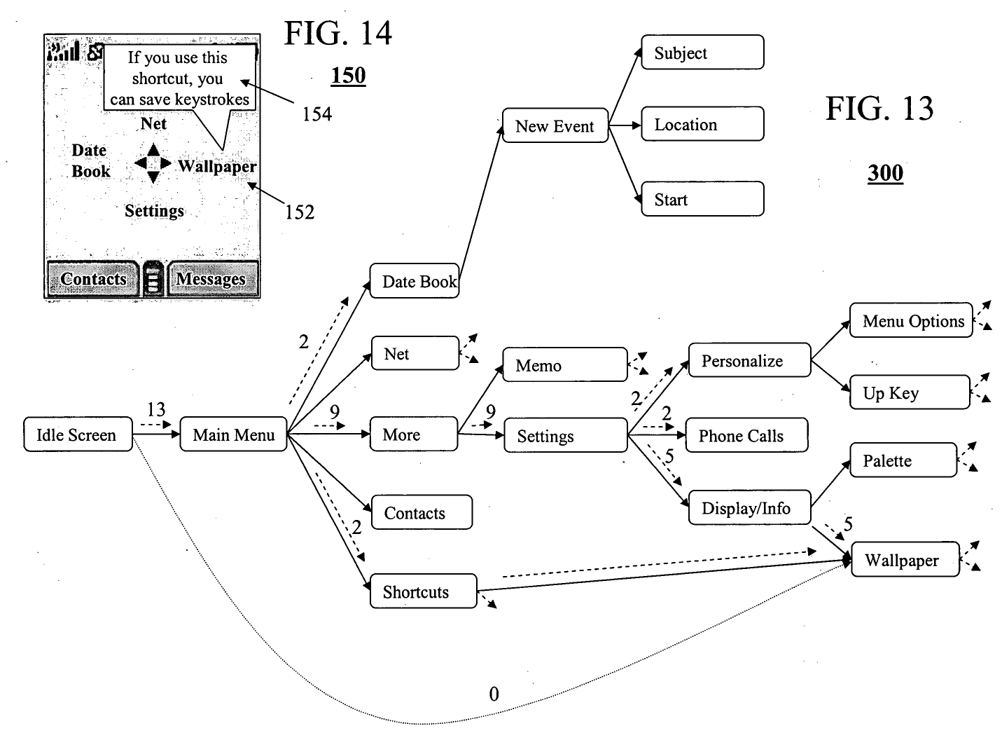

Referring to FIGS. 13 and 14, a particular example of an application tree 300 is shown where the pattern used is Idle Screen-Main Menu-More-Settings-Display/Info-Wallpaper (5 times). If the application is used, but the user continued using a long pattern rather than using an appropriate soft/hot key (A-T, never used), then the system can advise the user by introducing and encouraging the effective usage of shortcuts or soft/hot keys. In this regard, a pop-up dialog 154 can provide the appropriate advice regarding a “Wallpaper” soft/hot key 152 on the graphical UI 150 as illustrated in FIG. 14. Although FIG. 14 illustrates one way how the user can be informed about the shortest path to the same application after it was detected that the hot/soft keys was never used, it should be noted that other dialog forms can provide advice including voice prompts that use text-to-speech synthesis.

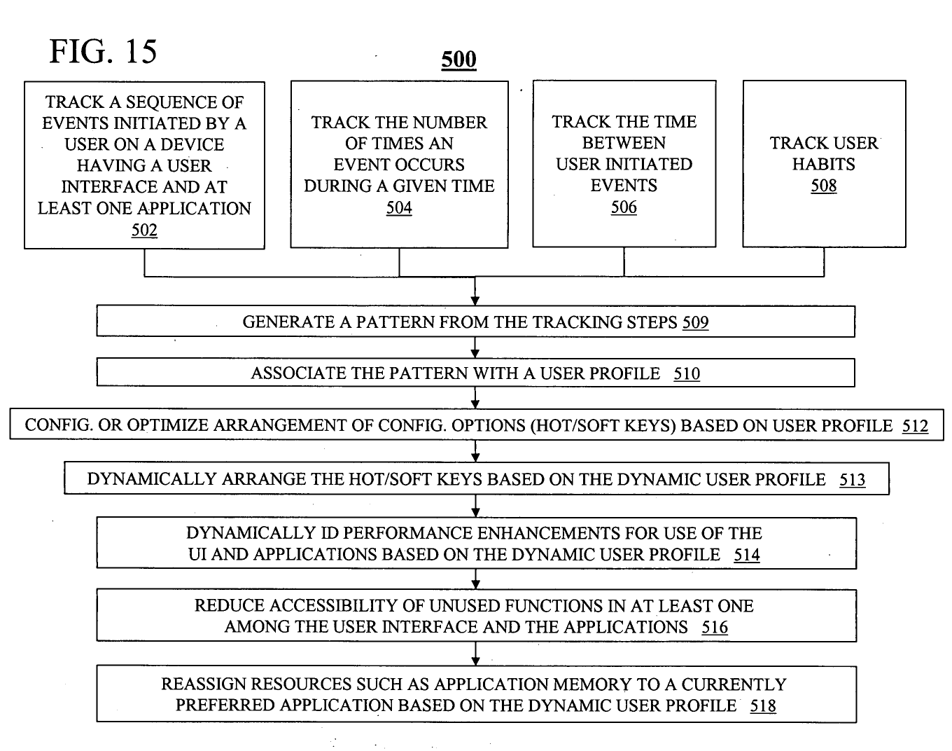

Referring to FIG. 15, a flow chart illustrating a method 500 of arranging configurable options such as hot/soft keys in a menu is shown. The method 500 can include one or more of the steps of tracking a sequence of events initiated by a user on a device having a user interface and at least one application at step 502, tracking the number of times an event occurs during a given time at step 504, tracking the time between user initiated events at step 506, and tracking user habits at step 508. The method can further include a step 509 of generating a pattern from the tracking steps, a step 510 of associating the pattern with a user profile, and a step 512 of configuring or optimizing an arrangement of configurable options (such as hot/soft keys in the menu) based on the user profile. Tracking can also include tracking usage of the user interface at different times, dates, and locations. The method can also include the optional steps of dynamically arranging the hot/soft keys based on the dynamic user profile at step 513 and dynamically identifying performance enhancements for use of the user interface and applications based on the dynamic user profile at step 514 as well as optionally reducing the accessibility of unused functions in at least one among the user interface and the applications at step 516. Optionally, the method 500 can also reassign resources such as application memory to a currently preferred application based on the dynamic user profile at step 518.

In light of the foregoing description, it should also be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of arranging configurable options on a menu, comprising the steps of:
tracking a sequence of events initiated by a user on a device having a user interface and at least one application;
tracking the number of times an event occurs during a given time;
tracking the time between user initiated events;
generating a pattern from the tracking steps;
associating the pattern with a user profile; and
configuring an arrangement of configurable options in the menu based on the user profile.

2. The method of claim 1, wherein the method further comprises the step of tracking usage of the user interface at different times, dates, and locations.

3. The method of claim 1, wherein the step of optimizing the arrangement of configurable options comprises the step of configuring an arrangement of hot/soft keys in the menu.

4. The method of claim 1, wherein the step of configuring comprises the step of applying a weighted average to at least some information being tracked in the tracking steps.

5. A method of arranging configurable options in a menu, comprising the steps of:
tracking user habits;
generating a dynamic user profile based on the user habits; and
dynamically arranging the configurable options based on the dynamic user profile.

6. The method of claim 5, wherein the step of dynamically arranging the configurable options comprises the step of dynamically arranging hot/soft keys in the menu.

7. The method of claim 5, wherein the method further comprises the step of dynamically identifying performance enhancements for use of the user interface and applications based on the dynamic user profile.

8. The method of claim 5, wherein the method further comprises the step of reducing accessibility of unused functions in at least one among the user interface and the applications.

9. The method of claim 5, wherein the method further comprises the step of reassigning resources to a preferred application based on the dynamic user profile.

10. A dynamically enhanced user interface having configurable options, comprising:
an event tracker;
an elapsed time tracker;
a user pattern profile generator receiving inputs from the event tracker and the time tracker and generating a user pattern profile in response to said inputs; and
a presentation device having set of configurable options that dynamically changes based on the user pattern profile.

11. The dynamically enhanced user interface of claim 10, wherein the configurable options comprises soft/hot keys on a menu.

12. The dynamically enhanced user interface of claim 10, wherein the user interface further comprises a configurable options manager that controls the arrangement of configurable options based on the user pattern profile generator.

13. The user interface of claim 11, wherein the user interface further comprises a soft/hot key manager that controls the arrangement of the soft/hot keys based on the user pattern profile generator.

14. The user interface of claim 10, wherein the user interface further comprises an advisor manager that monitors user pattern profile and suggests improvements in usage to a user.

15. The user interface of claim 10, wherein the presentation device comprises a display.

16. A machine readable storage, having stored thereon a computer program having a plurality of code sections executable by a machine for causing the machine to perform the steps of:
tracking a sequence of events initiated by a user on a device having a user interface and at least one application;
tracking the number of times an event occurs during a given time tracking the time between user initiated events;
generating a pattern from the tracking steps;
associating the pattern with a user profile; and
configuring an arrangement of hot/soft keys in the menu based on the user profile.

17. The machine readable storage of claim 16, wherein the machine readable storage is further programmed to cause the machine to track user habits, generate a dynamic user profile based on the user habits, and dynamically arrange the hot/soft keys based on the dynamic user profile.

18. The machine readable storage of claim 17, wherein the machine readable storage is further programmed to cause the machine to dynamically identify performance enhancements for use of the user interface and applications based on the dynamic user profile.

19. The machine readable storage of claim 16, wherein the machine readable storage is further programmed to cause the machine to reduce accessibility of unused functions in at least one among the user interface and the applications.
